(19) United States
(12) Patent Application Publication
(10) Pub. No.: US 2017/0011063 A1
(43) Pub. Date: Jan. 12, 2017

(54) Systems and Methods to Facilitate Submission of User Images Descriptive of Locations

(71) Applicant: Google Inc., Mountain View, CA (US)

(72) Inventors: Yongzhong Lee, Kawasaki (JP); David Robert Gordon, Tokyo (JP); Adrian Victor Velicu, Tokyo (JP); Toliver Jue, Tokyo (JP)

(21) Appl. No.: 14/792,296

(22) Filed: Jul. 6, 2015

(51) Int. Cl. G06F 17/30; G06K 9/00

(52) U.S. Cl. CPC G06F 17/30241; G06F 17/30265; G06F 17/30256; G06K 9/00624; G06K 9/00993

(57) ABSTRACT

Systems and methods to facilitate the submission of user images that are descriptive of a location or point of interest are provided. One example computer-implemented method includes determining a location at which a first image was captured by a mobile computing device. The method includes obtaining one or more semantic descriptors that semantically describe the location at which the first image was captured. The method includes analyzing the first image to determine one or more subjects of the first image. The method includes determining whether the one or more subjects of the first image are related to the one or more semantic descriptors that semantically describe the location. When it is determined that the one or more subjects of the first image are related to the one or more semantic descriptors that semantically describe the location, the method includes providing a user of the mobile computing device with an opportunity to associate the first image with the location.

### FIELD

The present disclosure relates generally to systems and methods to obtain images for locations and, more particularly, to systems and methods that facilitate the submission of user-captured images that are particularly descriptive of a location or point of interest.

### BACKGROUND

Review platforms provide an opportunity for users to contribute or browse reviews of locations such as commercial entities or other points of interest. For example, after eating at a particular restaurant, a user can visit a webpage in the review platform that corresponds to the particular restaurant and can contribute a review. The review can be numeric (e.g., 6/10 or 3 stars out of 5), textual (e.g., “great wine selection, but poor service”), or other formats.

Some review platforms also offer functionality for a user to upload photos, tag friends, or other interactive features. Thus, review platforms can be embedded within or an extension or feature of social media platforms, mapping applications, or some combination of mapping, social, and review services. Generally, such category of platforms or services that provide information regarding points of interest, locations, geographic features, and/or other geographically related information can be generally denominated as geographic information systems.

Once a review platform has accumulated a significant number of reviews it can be a useful resource for users to identify new entities or locales to visit or experience. For example, a user can visit the review platform to search for a restaurant at which to eat, a store at which to shop, or a place to have drinks with friends. The review platform can provide search results based on location, quality according to the reviews, pricing, and/or keywords included in textual reviews.

However, one challenge associated with launching or maintaining a review platform is obtaining a significant number of images of different locations or points of interest. In particular, images are one of the most effective ways for the review platform to provide users with the ability to quickly gain an understanding of the character, quality, or other unique features of a location. Thus, collection of images that are descriptive of various locations is desirable

Certain existing review platforms require users to manually upload images through the following tedious process. First, the user is required to open the geographic information system (e.g., maps application or review platform). Next, the user has to manually retrieve or navigate to the location depicted by the image. Finally, the user must manually select and submit the image(s).

Such manual process is inefficient and relies upon users to take proactive steps and expend their own time to submit images of locations. As such, many users likely capture images that constructively describe a location and would therefore be a useful addition to a review platform, but do not have sufficient incentives to expend the required effort to submit such images to the review platform.

In addition, even in the instance where a user makes the effort to submit an image, there is no guarantee that the submitted image is relevant or otherwise descriptive of the location for which it is associated. Thus, even assuming exceptional user effort, the resulting uploaded image may not be appropriate or otherwise descriptive of the type or unique character of the location. For example, images of decorative plants provide less descriptive value than do images of a steak if the location is a steakhouse or grill.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method to obtain images for locations. The method includes determining, by one or more computing devices, a location at which a first image was captured by a mobile computing device. The method includes obtaining, by the one or more computing devices, one or more semantic descriptors that semantically describe the location at which the first image was captured. The method includes analyzing, by the one or more computing devices, the first image to determine one or more subjects of the first image. The method includes determining, by the one or more computing devices, whether the one or more subjects of the first image are related to the one or more semantic descriptors that semantically describe the location. When it is determined that the one or more subjects of the first image are related to the one or more semantic descriptors that semantically describe the location, the method includes providing, by the one or more computing devices, a user of the mobile computing device with an opportunity to associate the first image with the location.

Another example aspect of the present disclosure is directed to a computer-implemented method. The method includes determining, by one or more computing devices, a location at which a plurality of images were captured by a mobile computing device. The method includes obtaining, by the one or more computing devices, one or more semantic descriptors that semantically describe the location at which the plurality of images were captured. The method includes analyzing, by the one or more computing devices, the plurality of images to respectively determine a plurality of subjects of the plurality of images. The method includes determining, by the one or more computing devices, a plurality of relevance scores respectively for the plurality of subjects of the plurality of images. The relevance score for the one or more subjects of each image is based at least in part on a comparison of such subject to the one or more semantic descriptors. The method includes selecting, by the one or more computing devices, one or more relevant images of the plurality of images based at least in part on the plurality of relevance scores. The method includes providing, by the one or more computing devices, a user of the mobile computing device with an opportunity to associate the one or more relevant images with the location.

Another example aspect of the present disclosure is directed to a computing system. The computing system includes a mobile computing device that includes a camera. The computing system includes a point of interest database that stores semantic descriptors and images associated with a plurality of locations. The semantic descriptors associated with each location respectively semantically describe such location. The point of interest database is a component of a geographic information system. The computing system includes one or more server computing devices communicatively coupled to the mobile computing device and to the point of interest database over a network. At least one of the mobile computing device and the one or more server computing devices comprises a non-transitory computer-readable medium storing instructions which, when executed by one or more processors, cause the at least one of the mobile computing device and the one or more server computing devices to: determine a location at which a first image was captured by the camera of the mobile computing device; obtain from the point of interest database a first set of semantic descriptors that semantically describe the location at which the first image was captured; analyze the first image to determine one or more subjects of the first image; determine whether the one or more subjects of the first image are related to the one or more semantic descriptors that semantically describe the location; and, when it is determined that the one or more subjects of the first image are related to the one or more semantic descriptors that semantically describe the location, cause a notification to be provided to a user of the mobile computing device. The notification provides the user of the mobile computing device with an opportunity to have the first image stored in the point of interest database and associated with the location.

Other aspects of the present disclosure are directed to systems, apparatus, tangible, non-transitory computer-readable media, user interfaces, and devices for scanning for facilitating submission of user images descriptive of a location.

These and other features, aspects, and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example notification according to an example embodiment of the present disclosure.

FIG. 2 depicts an example computing system according to an example embodiment of the present disclosure.

FIG. 3 depicts a flow chart diagram of an example method to obtain images of locations according to an example embodiment of the present disclosure.

FIG. 4 depicts a flow chart diagram of an example method to obtain images of locations according to an example embodiment of the present disclosure.

### DETAILED DESCRIPTION

The present disclosure provides systems and methods that facilitate the submission of user-captured images that are particularly descriptive of a location or point of interest. In particular, after a user has operated a mobile computing device to capture an image at a location, the systems and methods of the present disclosure can analyze the image to determine whether it is relevant or otherwise particularly descriptive of such location of capture. If the image is deemed to be sufficiently relevant to constructively or uniquely describe the location, the systems and methods of the present disclosure provide the user with a notification or prompt that provides an opportunity for the user to associate the image with the location, for example, by uploading the image to a geographic information system such as a maps application or a review platform.

In one particular example, upon detecting that an image has been captured, the mobile computing device or a server computing device communicatively coupled to the mobile computing device determines a location at which the image was captured. The mobile computing device or the communicatively coupled server then obtains one or more semantic descriptors that semantically describe such location. The mobile computing device or the communicatively coupled server analyzes the image to determine one or more subjects of the image and then determines whether the one or more subjects of the image are relevant to the location, for example, based on a comparison of the one or more subjects of the image with the one or more semantic descriptors. If the image is sufficiently relevant to the location, the user is provided with an opportunity to associate the image with the location. For example, the mobile computing device can provide a notification on a display of the device which permits the user to assent to submission of the image to a database associated with a geographic information system such as a maps application or a review platform. The image is then provided by the geographic information system to other users who interact with the geographic information system to explore or learn about the location.

In such fashion, the systems and methods of the present disclosure resolve the inefficiencies associated with requiring a user to manually upload images for contribution to a geographic information system such as a maps application or a review platform. Further, due to relevancy screening of the one or more subjects of the image, the systems and methods of the present disclosure prompt optional submission by the user for only those images which are sufficiently relevant to constructively describe the location of their capture. For example, for images captured at a restaurant, a user can be prompted to upload an image of an entrée, but not an image depicting a group of people posing together.

More particularly, in some implementations, capture of one or more images by the mobile computing device triggers performance of methods of the present disclosure. For example, the mobile computing device or the server communicatively coupled the mobile computing device can detect or otherwise sense or be informed that an image has been captured. Upon detection of such image capture event, the mobile computing device or the server communicatively coupled the mobile computing device can perform the image analysis and relevancy determination techniques described generally above. However, as discussed further below, user-captured images will not be analyzed by the systems of the present disclosure without first obtaining consent from the user.

As another example, performance of methods of the present disclosure can be triggered upon detecting a cluster of images have been captured. As yet another example, performance of methods of the present disclosure can be triggered when the mobile computing device changes locations and at least one image was captured at the previous location.

In some implementations, the image analysis and relevancy determination is performed locally at the mobile computing device. In other implementations, the image analysis and relevancy determination is performed by one or more server computing devices communicatively coupled to the mobile computing device. In such implementations, the mobile computing device can upload (e.g., autonomously or in response to a request by the server computing device) or otherwise transmit the captured image or images to the server computing devices.

The mobile computing device or server computing device initially determines a location of capture for each captured image. For example, the location of capture can be determined for an image based on metadata (e.g., EXIF data) associated with the image. As another example, data associated with a positioning system of the mobile computing device (e.g., GPS data, WiFi data) can be used to determine the location of image capture. For example, the current or historical location of the user as provided by the positioning system and/or associated user location history can be correlated to a time at which the image was captured to determine the location of image capture.

As yet another example, user data associated with the user of the mobile computing device, such as previous search data, reservation data, mobile payment data, or other user data can be used to determine and/or confirm the location of image capture. As another example, the image can be analyzed to determine whether the image depicts any identifying features or characteristics of the location of capture (e.g., does the image depict a well-known monument or other point of interest). However, as discussed further below, the user data described above will not be used or analyzed by the systems of the present disclosure without first obtaining consent from the user.

In some implementations, determining the location of capture can include identifying a point of interest at the location. For example, such information can be retrieved from a point of interest database that is, for example, associated with a geographic information system. For example, the point of interest database can include information for each of a plurality of points of interest, including respective geographic boundaries.

The mobile computing device or server computing device then obtains one or more semantic descriptors which semantically describe the determined location of capture. As one example, the semantic descriptors can be natural language words which describe a point of interest or other geographic entity at the determined location of capture. For example, a restaurant at a particular location might be described by the following semantic descriptors: restaurant, café, coffee, breakfast, casual, organic, brunch, bright, etc. As another example, a park at a particular location might be described by the following semantic descriptors: park, playground, fountain, museum, sculpture, bicycle, shady, grass, trees, picnic.

In some instances, the semantic descriptors can be categories into which the location or point of interest has previously been classified (e.g., according to classifications which serve to organize places or data contained in a geographic information system). As another example, the semantic descriptors can be retrieved or culled from user-submitted reviews of the point of interest or other semantic data sources such as a menu or website of the point of interest. As yet another example, the semantic descriptors for a location can be derived from an analysis of other images previously associated with the location. As another example, the semantic descriptors for a location may simply be or include the title or name of the location.

Furthermore, in some implementations, the obtained semantic descriptors can be supplemented with additional semantic descriptors which are related to obtained semantic descriptors or which otherwise serve to further describe the location. As one example, a knowledge web or other data structure that describes relationships between various semantic descriptors can be leveraged to obtain additional semantic descriptors which describe the location. To provide an example, if the semantic descriptor “breakfast” is obtained for a particular location, then such a knowledge web can be used to further obtain the following related semantic descriptors: coffee, eggs, toast, etc. In such fashion, existing knowledge of relationships between various semantic descriptors (e.g., natural language words) can be leveraged to obtain a significant number of semantic descriptors that describe a location.

In some implementations, the determined location of capture is expressed in the form of geographic coordinates such as latitude and longitude. In such implementations, obtaining the one or more semantic descriptors can include using the geographic coordinates to retrieve the one or more semantic descriptors from the point of interest database. For example, the geographic coordinates determined for the image can be used to retrieve semantic descriptors associated with such coordinates. Other implementations may leverage the same or a similar point of interest database without use of particular geographic coordinates.

The mobile computing device or server computing device analyzes the image to determine one or more subjects of the image. In particular, an image content analysis algorithm can be performed for the image to identify the one or more subjects depicted in the image. As examples, the image content analysis algorithm can include object detection, classification, and/or other similar techniques (e.g., appearance-based methods such as edge matching, greyscale matching, and/or gradient matching, and/or various feature-based methods).

Thus, in some implementations, the result of the image analysis can be a list or set of objects recognized as the one or more subjects of the image. In some instances, such list of subjects can be denominated as a second set of semantic descriptors that semantically describe the content of the image. Further, as described above, the list of subjects (which may be denominated as a second set of semantic descriptors) can be supplemented with additional related or similar subjects, words, or semantic descriptors through the use of a knowledge web that describes known relationships between words.

After obtaining the semantic descriptors for the location and determining one or more subjects of the image, the mobile computing device or server computing device determines whether the image is relevant to the semantic descriptors that semantically describe the location. As an example, determining whether the image is relevant to the semantic descriptors can include comparing the one or more subjects determined for the image with the one or more semantic descriptors. For example, the mobile or server computing device can determine whether the one or more semantic descriptors semantically describe the one or more subjects. Such may include determining whether the subjects fall under a category or list of items described by any of the semantic descriptors.

In instances in which a second set of semantic descriptors is determined for the image, determining the relevancy of the image can include comparing such second set of semantic descriptors with the first set of semantic descriptors obtained for the location. For example, similar or shared semantic descriptors can be identified. One or more shared or similar semantic identifiers between sets can indicate an image is more relevant, while no or few shared or similar semantic identifiers can indicate that an image is less relevant.

In some implementations, determining whether the image is relevant to the semantic descriptors includes generating a relevance score for the image. As an example, a scoring formula can be used to generate the relevance score based on the results of the various example comparisons discussed above. For example, the scoring formula can provide a higher relevance score for an image if the subjects of the image are described by or share descriptors with the semantic descriptors obtained for the location. Likewise, the scoring formula can provide a lower relevance score for an image if the subjects of the image are neither described by nor share descriptors with the semantic descriptors obtained for the location. In some implementations, an image will be deemed relevant to the location only if the relevance score determined for such image exceeds a threshold value.

According to another aspect of the present disclosure, determining whether the image is relevant to the location can include screening out (e.g., deeming not relevant) images for which the primary subjects are human faces. Thus, in such implementations, analyzing the first image can include determining whether the first image depicts one or more human faces. In further implementations, a relative primacy of the depicted human faces can be determined as well. In some implementations, images that depict human faces (e.g., as a primary feature) are deemed not relevant to the location as a rule. In other implementations, the number and/or relative primacy of human faces can be considered as a factor when determining relevancy without application of a strict rule. For example, the inclusion of one or more human faces or other portions of humans can negatively affect the relevance score determined for an image.

In such fashion, user-captured images which have the user and/or other related persons as their primary subject will be deemed not relevant for submission to the geographic information system. Likewise, images which do not have the user and/or other related persons as their primary subject will be deemed more relevant, as they are more likely to show features of the location which constructively or uniquely describe the location for other unassociated users. For example, an image of an entrée at a restaurant more constructively describes the restaurant to the benefit of other unassociated users than does an image of the user with her family at the restaurant.

If the image is determined to be relevant to the location, the user is provided with an opportunity to associate the image with the location. In particular, the mobile computing device can autonomously or can be instructed by the server to provide a notification or other alert on a display of the mobile computing device. As an example, the notification can show the image, identify the location, and request that the user assent to upload of the image with the location within a geographic information system. For example, the notification can request that the user assent to uploading or submission of the image to the geographic information system such as a maps application or review platform.

In some implementations, the notification can provide the user with a selection to upload the image to be associated with a description of an attribute the location. In particular, in some instances, the image can be recognized as being descriptive of a particular aspect or attribute of the location. For example, an image can be descriptive of the décor, food, restrooms, outdoor space, a particular component or feature and/or other attribute of a particular location. In some instances, attributes can be secondary attributes (e.g., non-primary) of a location. Thus, images can describe attributes of a location that are not commonly thought of or popular components of the location (e.g., an image can describe a particular bench within a park). Thus, the notification or prompt can provide the user with an opportunity to select, confirm, and/or identify a particular attribute of the location for which the image is descriptive. Further, in some implementations, multiple sets of semantic descriptors can be obtained for various attributes of a location and can be used to respectively determine a relevance of an image to each of such attributes (e.g., an image may be determined to be relevant to the quality of restrooms available at a zoo but not relevant to or descriptive of a particular animal attraction).

If the user assents to association of the image with the location, the image will be submitted or uploaded to a database associated with the geographic information system. The image will be associated with the location and can be provided to other unassociated users who interact with geographic information system to explore or learn about the particular location. However, if the user does not assent to association of the image with the location, the image will not be uploaded, submitted, or otherwise made public.

If the image is determined to not be relevant to the location, then the mobile computing device does not provide the notification to the user. The process can end upon such determination of non-relevance or can proceed to consider additional images recently captured by the mobile computing device at the same location.

In some implementations, in order to obtain the benefits of the techniques described herein, the user may be required to allow the collection and analysis of images, location information, search information, and/or other data associated with the user or the user's mobile computing device. Therefore, in some implementations, users may be provided with an opportunity to adjust settings that control whether and how much the systems of the present disclosure collect and/or analyze such information. However, if the user does not allow collection and use of such information, then the user may not receive the benefits of the techniques described herein. In addition, in some embodiments, certain information or data can be treated in one or more ways before or after it is used, so that personally identifiable information is removed or not stored permanently.

With reference now to the Figures, example embodiments of the present disclosure will be discussed in further detail.

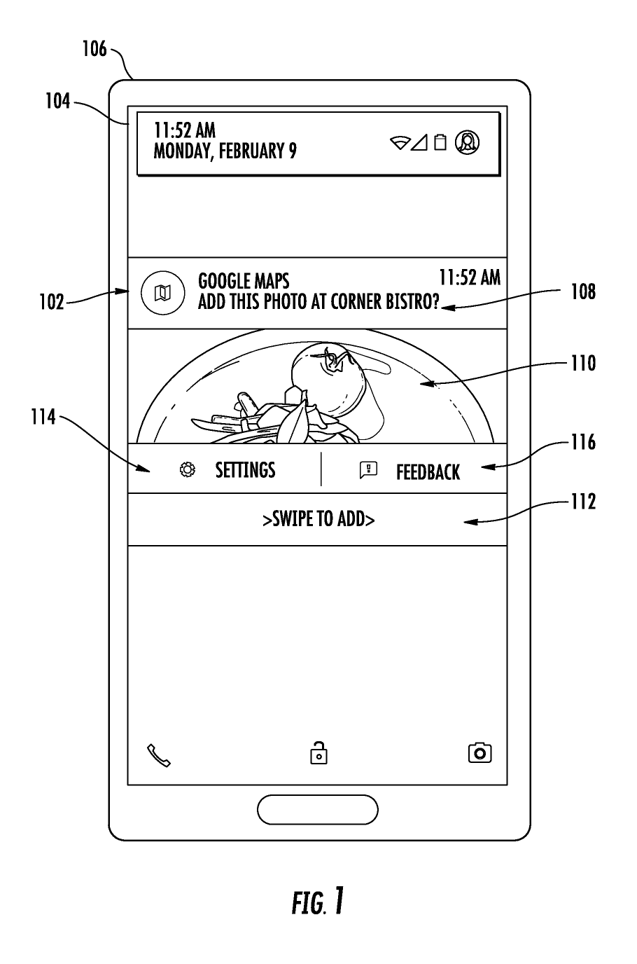

FIG. 1 depicts an example notification 102 according to an example embodiment of the present disclosure. In particular, FIG. 1 depicts the example notification 102 as displayed on a display 104 of a mobile computing device 106.

Notification 102 can provide an opportunity for a user of the mobile computing device 106 to upload an image 110 to a geographic information system such as a maps application or a review platform. For example, notification 102 can be a prompt and can take the form of a card or other display item that can be presented to the user.

In one implementation, notification 102 is pushed from a server computing device to the mobile computing device 106 within the context of a maps application installed on the mobile computing device 106. In other implementations, the application of the mobile computing device 106 can be stylized as a personal assistant. In yet other implementations, notification 102 is provided to the mobile computing device 106 by means of electronic mail, SMS technology, or any other suitable communication mechanism or mode of operation. As yet another example, the mobile computing device 106 can generate the notification 102 without having had any communication with an additional computing device (e.g., server computing device).

Mobile computing device 106 can display the notification 102 while the mobile computing device 106 is in a lock screen mode or during active operation of the mobile computing device 106 by the user.

Notification 102 can include a headline 108. Headline 108 can request that the user of the mobile computing device 106 assent to submission of a photograph 110 to a geographic information system. In particular, the headline 108 or other portions of the notification 102 can identify the particular location with which the image 110 will be associated. For example, notification 102 asks the user if the user would like to associate the image 110 with a particular restaurant named Corner Bistro.

The notification 102 can include a toggle, button, or other interactive feature 112 with which the user can interact to assent or decline to add the image 110 to the geographic information system. For example, if the user swipes rightward on feature 112, such action indicates that the user assents to addition of the image 110 to the geographic information system.

Although only a single image 110 is depicted in FIG. 1, in some implementations of the present disclosure, a user can be prompted to assent to submission of a plurality of images. As one example, in some implementations, the notification 102 can include a plurality of images from which the user is requested to optionally select one or more for submission. For example, the user can swipe between the images and select one or more for submission. Thus, in some implementations, the system implementing the present disclosure selects several images which are relevant to the location and provides the user with the option of selecting one or more for submission.

Notification 102 can further include one or more additional interactive elements. For example, notification 102 can include an interactive settings feature 114 in which the user can adjust, as examples, privacy controls, a rate at which notifications 102 are provided, or other settings. Notification 102 can further include an interactive feedback feature 116, in which the user can provide feedback to the application developer.

As yet another example, notification 102 can include a user-selectable link or other feature selection of which results in mobile device 106 loading or accessing a social media landing page, comment page, rating page, feedback mechanism, or any other desired additional content, feature, or application. Similarly, notification 102 can include interactive features which allow the user to directly provide a review (e.g., a textual review or a numeric review) of the location alternatively or in addition to submission of the image 110.

In yet further implementations, the notification 102 allows the user to correct or otherwise change the location with which the image 110 will be associated. As another example, the notification 102 can include further interactive features which allow the user to edit (e.g., crop, filter, annotate, etc.) the image 110 prior to submission.

The particular depiction of notification 102 provided in FIG. 1 is provided as one example notification. As such, various interactive or non-interactive elements of various designs can be included in notification 102 without deviating from the scope of the present disclosure.

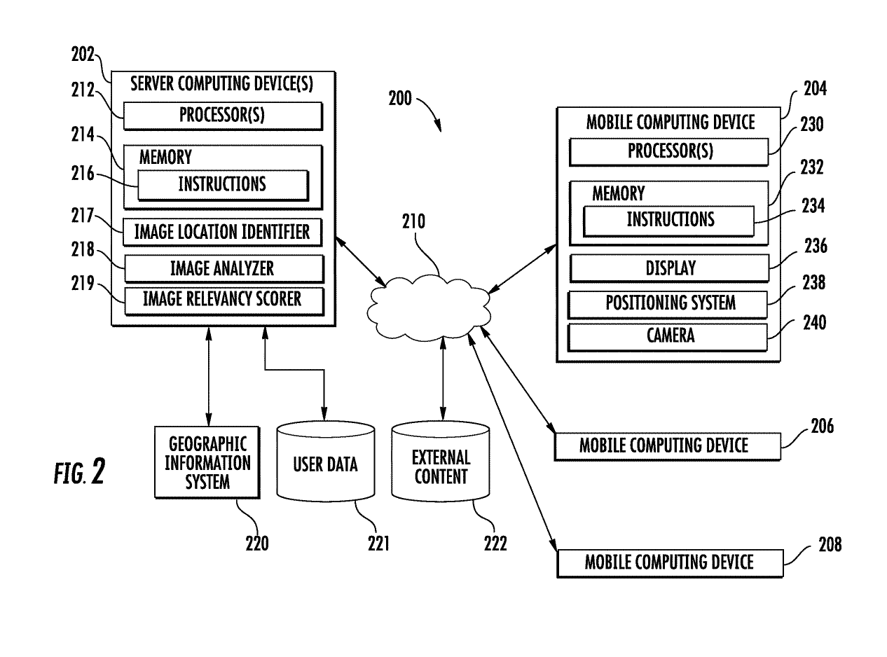

FIG. 2 depicts an example system 200 according to an example embodiment of the present disclosure. System 200 can include a client-server architecture, where a server computing device 202 communicates with one or more mobile computing devices 204, 206, and 208 over a network 210. Although three mobile computing devices 204, 206, and 208 are illustrated in FIG. 2, any number of mobile computing devices can be connected to server computing device 202 over network 210.

Mobile computing devices 204, 206, and 208 can be, for example, a computing device having a processor 230 and a memory 232, such as a wireless mobile device, a personal digital assistant (PDA), smartphone, tablet, navigation system located in a vehicle, handheld GPS system, laptop computer, computing-enabled watch, computing-enabled eyeglasses, camera, embedded computing system, or other such devices/systems. In short, mobile computing device 204 can be any computer, device, or system that can interact with the server computing device 202 (sending and receiving data) to implement the present disclosure.

Processor 230 of mobile computing device 204 can be any suitable processing device and can be one processor or a plurality of processors that are operably connected. Memory 232 can include any number of computer-readable instructions 234 or other stored data. In particular, the instructions 234 stored in memory 232 can include one or more applications. When implemented by processor 230, applications can respectively cause or instruct processor 230 to perform operations consistent with the present disclosure, such as, for example, executing a mapping application or a browser application in order to interact with a mapping system. Memory 232 can also store any number of images captured by the mobile computing device 204.

Further, any of the processes, operations, programs, applications, or instructions described as being stored at or performed by the server computing device 202 can instead be stored at or performed by the mobile computing device 204 in whole or in part.

Mobile computing device 204 can further include a display 236. The display can be any one of many different technologies for displaying information to a user, including touch-sensitive display technologies.

Mobile computing device 204 can further include a positioning system 238. Positioning system 238 can determine a current geographic location of mobile computing device 204 and communicate such geographic location to server computing device 202 over network 210. The positioning system 238 can be any device or circuitry for analyzing the position of the mobile computing device 204. For example, the positioning system 238 can determine actual or relative position by using a satellite navigation positioning system (e.g., a GPS system, a Galileo positioning system, the GLObal Navigation satellite system (GLONASS), the BeiDou Satellite Navigation and Positioning system), an inertial navigation system, a dead reckoning system, based on IP address, by using triangulation and/or proximity to cellular towers or WiFi hotspots, and/or other suitable techniques for determining position or combinations thereof.

In the instance in which the user consents to the use of positional or location data, the positioning system 238 can analyze the position of the mobile computing device 204 as the user moves around in the world and provides the current location of mobile computing device 204 to the server computing device 202 over network 210.

Mobile computing device 204 can further include a camera 240. Camera 240 can include any form of device capable of capturing images. However, camera 240 will typically be a digital camera. The processor 230 can communicate with or control camera 240. Images captured by camera 240 can be stored in memory 232 and, in the instance in which the user consents to such use, transmitted by mobile computing device 204 to server computing device 202 over network 210.

Server computing device 202 can be implemented using one or more server computing devices and can include a processor 212 and a memory 214. In the instance that server computing device 202 consists of multiple server devices, such server devices can operate according to any computing architecture, including a parallel computing architecture, a distributed computing architecture, or combinations thereof.

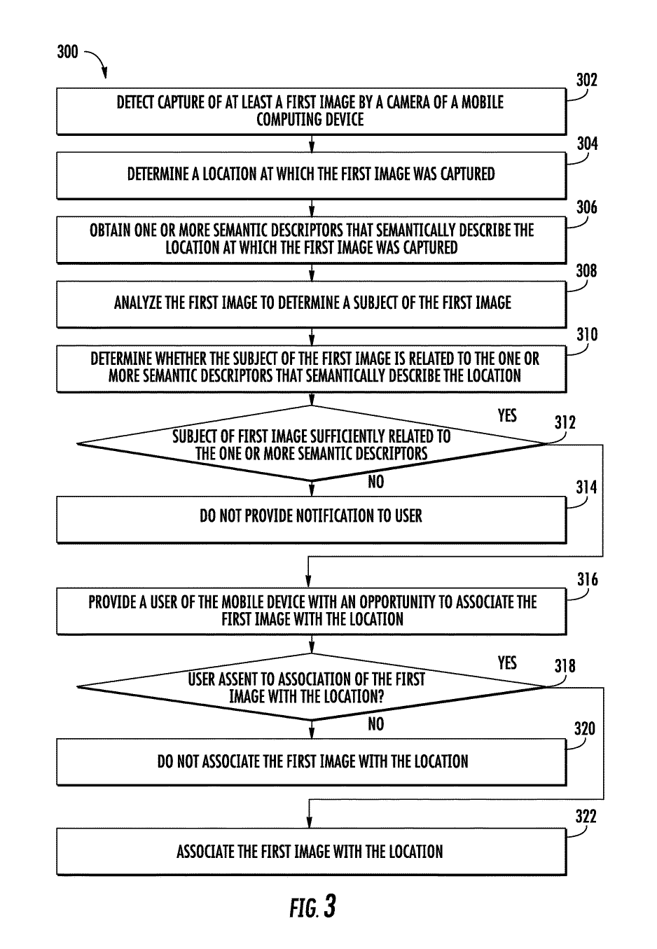

Processor 212 can be any suitable processing device and can be one processor or a plurality of processors which are operably connected. Memory 214 can store instructions 216 that cause processor 212 to perform operations to implement the present disclosure, including performing aspects of method 300 of FIG. 3 and/or method 400 of FIG. 400.

Server computing device 202 can also include an image location identifier 217, an image analyzer 218, and an image relevancy scorer 219. Each of image location identifier 217, image analyzer 218, and image relevancy scorer 219 include computer logic utilized to provide desired functionality. Thus, each of image location identifier 217, image analyzer 218, and image relevancy scorer 219 can be implemented in hardware, firmware and/or software controlling a general purpose processor. In some implementations, each of image location identifier 217, image analyzer 218, and image relevancy scorer 219 are program code files stored on the storage device, loaded into memory 214 and executed by processor 212 or can be provided from computer program products, for example, computer executable instructions that are stored in a tangible computer-readable storage medium such as RAM hard disk or optical or magnetic media.

Server computing device 202 can implement the image location identifier 217 to determine a location at which an image was captured. For example, the image location identifier 217 can be implemented to analyze image metadata, data from the positioning system 238, user data 221, the content of the image, and/or other information to determine the location at which a particular image was captured.

Server computing device 202 can implement the image analyzer 218 to determine one or more subjects of a particular image. For example, the image analyzer 218 can be implemented to perform an image content analysis algorithm which includes object detection, classification, and/or other similar techniques.

Server computing device 202 can implement the image relevancy scorer 219 to assess a relevance of an image for a location. For example, the image relevancy scorer 219 can be implemented to determine a relevance score for an image according to a scoring formula. For example, the image relevancy scorer 219 can compare the one or more subjects of an image to one or more semantic descriptors that describe a location to determine a relevance of the image for the location.

Network 210 can be any type of communications network, such as a local area network (e.g., intranet), wide area network (e.g., Internet), or some combination thereof and can include any number of wired or wireless links. In general, communication between the server computing device 202 and the mobile computing device 204 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL). Server computing device 202 can communicate with mobile computing device 204 over network 210 by sending and receiving data.

Server computing device 202 can be coupled to or in communication with one or more databases, including user data 221 and external content 222. Although databases 221 and 222 are depicted in FIG. 2 as external to server computing device 202, one or more of such databases can be included in memory 214 of server computing device 202. Further, databases 221 and 222 can each correspond to a plurality of databases rather than a single data source.

In some implementations of the present disclosure, to assist in identifying the location at which an image was captured, server computing device (or another associated computing device such as mobile computing device 204) can analyze user data 221. User data 221 can include, but is not limited to, email data including textual content, images, email-associated calendar information, or contact information; social media data including comments, reviews, check-ins, likes, invitations, contacts, or reservations; calendar application data including dates, times, events, description, or other content; virtual wallet data including purchases, electronic tickets, coupons, or deals; game application data, including location-based game data; scheduling data; location data; or any other suitable data associated with a user account. Generally such data is analyzed to determine locations which the user is expecting to visit or has recently visited.

Importantly, the above provided examples of user data 221 are simply provided for the purposes of illustrating example data that could be analyzed to identify an image location in some potential implementations. However, such user data is not collected, used, or analyzed unless the user has provided consent after being informed of what data is collected and how such data is used. Further, the user can be provided with a tool to revoke or modify the scope of permissions. In addition, certain information or data can be treated in or more ways before it is stored or used, so that personally identifiable information is removed or stored in an encrypted fashion.

Server computing device 202 can be coupled to or in communication with a geographic information system 220. Geographic information system 220 can store or provide geospatial data to be used by server computing device 202. Example geospatial data includes geographic imagery (e.g., digital maps, satellite images, aerial photographs, street-level photographs, synthetic models, etc.), tables, vector data (e.g., vector representations of roads, parcels, buildings, etc.), point of interest data, or other suitable geospatial data. Geographic information system 220 can include a point of interest database. Geographic information system 220 can be used by server computing device 202 to perform point of interest searches, provide point of interest location or categorization data, determine distances, routes, or travel times between locations, or any other suitable use or task required or beneficial for implementing the present disclosure.

As used herein, a “point of interest” refers to any feature, landmark, business, or other object, place, or event associated with a geographic location. For instance, a point of interest can include a business, restaurant, retail outlet, coffee shop, bar, music venue, attraction, museum, theme park, arena, stadium, festival, organization, entity, municipality, locality, city, state, or other suitable points of interest.

Computer-based system 200 can further include external content 222. External content 222 can be any form of external content including news articles, webpages, video files, audio files, written descriptions, ratings, game content, social media content, photographs, commercial offers, or other suitable external content. Server computing device 202 and mobile computing device 204 can access external content 222 over network 210. External content 222 can be searched by server computing device 202 according to searching techniques and can be ranked according to relevance, popularity, or other suitable attributes, including location-specific filtering or promotion.

FIG. 3 depicts a flowchart of an example method 300 for facilitating submission of user-captured images that a descriptive of locations. While example method 300 will be discussed with reference to the system 200 of FIG. 2, method 300 can be implemented using any suitable computing system.

In addition, although FIG. 3 depicts steps performed in a particular order for purposes of illustration and discussion, methods of the present disclosure are not limited to such particular order or arrangement. The various steps of the method 300 can be omitted, rearranged, combined, and/or adapted in various ways without deviating from the scope of the present disclosure.

At 302, the server computing device 202 detects capture of at least a first image by the camera 240 of the mobile computing device 204. More particularly, in some implementations, capture of one or more images by the mobile computing device 202 triggers performance of methods of the present disclosure. For example, the mobile computing device 202 or server computing device 202 can detect or otherwise sense or be informed that an image has been captured.

As another example, at 302, the server computing device 202 detects capture of a cluster of images by mobile computing device 204. As yet another example, at 302, the server computing device 202 detects that the mobile computing device 204 has changed locations and at least one image was captured at the previous location.

At 304, the server computing device 202 determines a location at which the first image was captured. For example, server computing device 202 can implement image location identifier 217 to determine the location at which the first image was captured.

For example, the image location identifier 217 can determine the location of capture for the first image based on metadata (e.g., EXIF data) associated with the image. As another example, the image location identifier 217 can use data associated with a positioning system of the mobile computing device (e.g., GPS data, WiFi data) to determine the location of image capture. For example, the current or historical location of the user as provided by the positioning system 238 and/or associated user location history (from user data 221) can be correlated to a time at which the first image was captured to determine the location of image capture.

As yet another example, the image location identifier 217 can use user data 221 associated with the user of the mobile computing device 204, such as previous search data, reservation data, mobile payment data, or other user data to determine and/or confirm the location of image capture. As another example, the image location identifier 217 can analyze the image to determine whether the image depicts any identifying features or characteristics of the location of capture (e.g., does the image depict a well-known monument or other point of interest). However, as discussed above, the user data 221 will not be used or analyzed by the systems of the present disclosure without first obtaining consent from the user.

In some implementations, determining the location of capture at 304 can include identifying a point of interest at the location. For example, server computing device 202 can retrieve such information from a point of interest database that is, for example, associated with geographic information system 220. For example, the point of interest database can include information for each of a plurality of points of interest, including respective geographic boundaries.

At 306, the server computing device 202 obtains one or more semantic descriptors that semantically describe the location at which the first image was captured. As one example, the semantic descriptors can be natural language words which describe a point of interest or other geographic entity at the determined location of capture.

In some instances, the semantic descriptors can be categories into which the location or point of interest has previously been classified (e.g., according to classifications which serve to organize places or data contained in geographic information system 220). As another example, the server computing device 202 can retrieve or cull the semantic descriptors from user-submitted reviews of the location or point of interest or other semantic data sources such as a menu or website of the location or point of interest. As yet another example, the server computing device 202 can derive the semantic descriptors for a location from an analysis of other images previously associated with the location. As another example, the semantic descriptors for a location may simply be or include the title or name of the location.

In some implementations, the determined location of capture is expressed in the form of geographic coordinates such as latitude and longitude. In such implementations, obtaining the one or more semantic descriptors at 306 can include using the geographic coordinates to retrieve the one or more semantic descriptors from the point of interest database included in geographic information system 220. For example, the geographic coordinates determined for the image can be used to retrieve semantic descriptors associated with such coordinates.

At 308, the server computing device 202 analyzes the first image to determine one or more subjects of the first image. For example, server computing device 202 can implement the image analyzer 218 to perform an image content analysis algorithm which includes object detection, classification, and/or other similar techniques.

In some implementations, the result of the image analysis at 308 can be a list or set of objects recognized as the one or more subjects of the image. In some instances, such list of subjects can be denominated as a second set of semantic descriptors that semantically describe the content of the image.

At 310, the server computing device 202 determines whether the one or more subjects of the first image are related to the one or more semantic descriptors that semantically describe the location at which the first image was captured. For example, server computing device 202 can implement image relevancy scorer 219 to determine whether the one or more subjects of the first image are related to the one or more semantic descriptors (e.g., by computing a relevance score for the first image).

As an example, determining whether the image is relevant to the semantic descriptors at 310 can include comparing the one or more subjects determined for the image with the one or more semantic descriptors. For example, the server computing device 202 can determine whether the one or more semantic descriptors semantically describe the one or more subjects determined at 308. Such may include determining whether the subjects fall under a category or list of items described by any of the semantic descriptors.

In instances in which a second set of semantic descriptors is determined for the image, determining the relevancy of the image at 310 can include comparing such second set of semantic descriptors with the first set of semantic descriptors obtained for the location. For example, similar or shared semantic descriptors can be identified. One or more shared or similar semantic identifiers between sets can indicate an image is more relevant, while no or few shared or similar semantic identifiers can indicate that an image is less relevant.

In some implementations, at 310, determining whether the image is relevant to the semantic descriptors includes generating a relevance score for the image. As an example, the image relevancy scorer 219 can use a scoring formula to generate the relevance score based on the results of the various example comparisons discussed above. For example, the scoring formula can provide a higher relevance score for an image if the subjects of the image are described by or share descriptors with the semantic descriptors obtained for the location. Likewise, the scoring formula can provide a lower relevance score for an image if the subjects of the image are neither described by nor share descriptors with the semantic descriptors obtained for the location.

According to another aspect of the present disclosure, at 310, determining whether the image is relevant to the location can include screening out (e.g., deeming not relevant) images for which the primary subjects are human faces. Thus, in such implementations, analyzing the first image at 308 can include determining whether the first image depicts one or more human faces. In further implementations, a relative primacy of the depicted human faces can be determined at 308 as well. In some implementations, at 310, images that depict human faces (e.g., as a primary feature) are deemed not relevant to the location as a rule. In other implementations, the number and/or relative primacy of human faces can be considered as a factor when determining relevancy at 310 without application of a strict rule. For example, the inclusion of one or more human faces or other portions of humans can negatively affect the relevance score determined for an image at 310.

In such fashion, the server computing device 202 will deem user-captured images which have the user and/or other related persons as their primary subject not relevant for submission to the geographic information system. Likewise, the server computing device will deem images which do not have the user and/or other related persons as their primary subject more relevant, as they are more likely to show features of the location which constructively or uniquely describe the location for other unassociated users.

At 312, the server computing device 202 determines whether the one or more subjects of the first image are sufficiently related to the one or more semantic descriptors. For example, in some implementations, the determination performed at 312 can include determining whether a relevance score determined for the image exceeds a threshold relevancy value.

If the server computing device 202 determines at 312 that the one or more subjects of first image are not sufficiently related to the one or more semantic descriptors, the method 300 proceeds to 314. At 314, neither the server computing device 202 nor the mobile computing device 204 provide a notification to the user.

However, if the server computing device 202 determines at 312 that the one or more subjects of the first image are sufficiently related to the one or more semantic descriptors, then method 300 proceeds to 316.

At 316, the server computing device 202 and the mobile computing device 204 cooperatively operate to provide the user of the mobile device with an opportunity to associate the first image with the location. For example, the mobile computing device 204 can display the notification 102 of FIG. 1 on the display 236 of the mobile computing device 204.

At 318, the server computing device 202 determines whether the user has assented to association of the first image with the location. For example, at 316, the server computing device 202 can determine whether it has received data from mobile computing device 204 which indicates that the user has assented to association of the first image with the location.

If the user has not assented to association of the first image with the location, then at 320, the server computing device 202 does not associate the first image with the location.

However, if the server computing device 202 determines at 318 that the user has assented to association of the first image with the location, then method 300 proceeds to 322.

At 322, the server computing device 202 associates the first image with the location. For example, at 322, the server computing device 202 can store the first image in the geographic information system 220 and associate such image with the location according to any of various database management techniques. Thereafter, the geographic information system 220 or an associated server system can provide the first image to additional users who interact with the geographic information system 220 to learn about or review the location.

Although certain portions of method 300 have been discussed as being performed by the server computing device 202, in some implementations, such portions are performed by the mobile computing device 204. Likewise, although certain portions of method 300 have been discussed as being performed by the mobile computing device 204, in some implementations, such portions are performed by the server computing device 202.

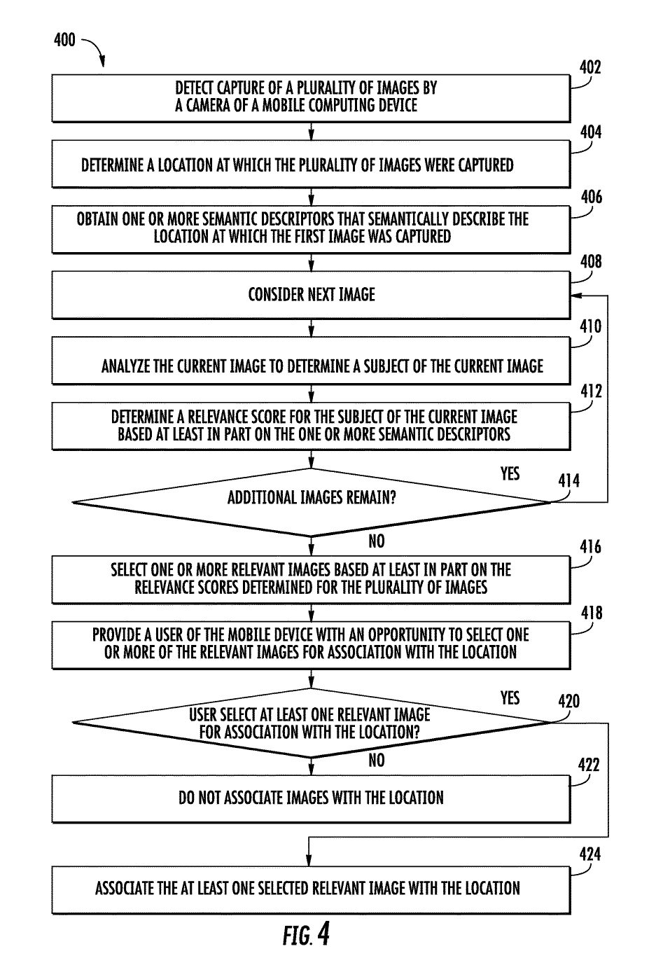

FIG. 4 depicts a flowchart of an example method 400 for facilitating submission of user-captured images that a descriptive of locations. While example method 400 will be discussed with reference to the system 200 of FIG. 2, method 400 can be implemented using any suitable computing system.

In addition, although FIG. 4 depicts steps performed in a particular order for purposes of illustration and discussion, methods of the present disclosure are not limited to such particular order or arrangement. The various steps of the method 300 can be omitted, rearranged, combined, and/or adapted in various ways without deviating from the scope of the present disclosure.

At 402, the server computing device 202 detects capture of a plurality of images by the camera 240 of the mobile computing device 204. More particularly, in some implementations, capture of a plurality of images by the mobile computing device 202 triggers performance of methods of the present disclosure. As one example, at 402, the server computing device 202 can detect capture of a cluster of images by mobile computing device 204.

At 404, the server computing device 202 determines a location at which the plurality of images were captured. For example, server computing device 202 can implement image location identifier 217 to determine the location at which the plurality of images were captured.

For example, the image location identifier 217 can determine the location of capture for the plurality of images based on metadata (e.g., EXIF data) associated with one or more of the plurality of images. As another example, the image location identifier 217 can use data associated with a positioning system of the mobile computing device (e.g., GPS data, WiFi data) to determine the location of image capture. For example, the current or historical location of the user as provided by the positioning system 238 and/or associated user location history (from user data 221) can be correlated to a time at which the plurality of images were captured to determine the location of image capture.

As yet another example, the image location identifier 217 can use user data 221 associated with the user of the mobile computing device 204, such as previous search data, reservation data, mobile payment data, or other user data to determine and/or confirm the location of image capture. As another example, the image location identifier 217 can analyze one or more of the plurality of images to determine whether such images depict any identifying features or characteristics of the location of capture (e.g., does the image depict a well-known monument or other point of interest). However, as discussed above, the user data 221 will not be used or analyzed by the systems of the present disclosure without first obtaining consent from the user.

In some implementations, determining the location of capture at 404 can include identifying a point of interest at the location. For example, server computing device 202 can retrieve such information from a point of interest database that is, for example, associated with geographic information system 220. For example, the point of interest database can include information for each of a plurality of points of interest, including respective geographic boundaries.

At 406, the server computing device 202 obtains one or more semantic descriptors that semantically describe the location at which the first image was captured. As one example, the semantic descriptors can be natural language words which describe a point of interest or other geographic entity at the determined location of capture.

In some instances, the semantic descriptors can be categories into which the location or point of interest has previously been classified (e.g., according to classifications which serve to organize places or data contained in geographic information system 220). As another example, the server computing device 202 can retrieve or cull the semantic descriptors from user-submitted reviews of the location or point of interest or other semantic data sources such as a menu or website of the location or point of interest. As yet another example, the server computing device 202 can derive the semantic descriptors for a location from an analysis of other images previously associated with the location. As another example, the semantic descriptors for a location may simply be or include the title or name of the location.

In some implementations, the determined location of capture is expressed in the form of geographic coordinates such as latitude and longitude. In such implementations, obtaining the one or more semantic descriptors at 406 can include using the geographic coordinates to retrieve the one or more semantic descriptors from the point of interest database included in geographic information system 220. For example, the geographic coordinates determined for the image can be used to retrieve semantic descriptors associated with such coordinates or associated with an area that includes such coordinates.

At 408 the server computing device 202 considers the next image of the plurality of images. More particularly, in some implementations of the present disclosure, the server computing device 202 can individually consider each of the plurality of images. Thus, at the first instance of 408, the server computing device 202 can consider a first image of the plurality of images. In other implementations, the plurality of images are considered in parallel or aggregately as a set.

At 410, the server computing device 202 analyzes the current image to determine one or more subjects of the current image. For example, server computing device 202 can implement the image analyzer 218 to perform an image content analysis algorithm which includes object detection, classification, and/or other similar techniques.

In some implementations, the result of the image analysis at 410 can be a list or set of objects recognized as the one or more subjects of the image. In some instances, such list of subjects can be denominated as a second set of semantic descriptors that semantically describe the content of the image.

At 412, the server computing device 202 determines a relevance score for the one or more subjects of the current image based at least in part on the one or more semantic descriptors. For example, the server computing device 202 can implement the image relevancy scorer 219 to determine whether the one or more subjects of the current image are related to the one or more semantic descriptors (e.g., by computing a relevance score for the current image).

As an example, determining the relevance score for the current image at 412 can include comparing the one or more subjects determined for the image with the one or more semantic descriptors. For example, the server computing device 202 can determine whether the one or more semantic descriptors semantically describe the one or more subjects determined at 410. Such may include determining whether the subjects fall under a category or list of items described by any of the semantic descriptors.

In instances in which a second set of semantic descriptors is determined for the image, determining the relevance score for the current image at 412 can include comparing such second set of semantic descriptors with the first set of semantic descriptors obtained for the location. For example, similar or shared semantic descriptors can be identified. One or more shared or similar semantic identifiers between sets can indicate an image is more relevant, while no or few shared or similar semantic identifiers can indicate that an image is less relevant.

As an example, the image relevancy scorer 219 can use a scoring formula to generate the relevance score based on the results of the various example comparisons discussed above. For example, the scoring formula can provide a higher relevance score for an image if the subjects of the image are described by or share descriptors with the semantic descriptors obtained for the location. Likewise, the scoring formula can provide a lower relevance score for an image if the subjects of the image are neither described by nor share descriptors with the semantic descriptors obtained for the location.

According to another aspect of the present disclosure, at 412, determining the relevance score for the current image can include screening out (e.g., deeming not relevant) images for which the primary subjects are human faces. Thus, in such implementations, analyzing the current image at 410 can include determining whether the current image depicts one or more human faces. In further implementations, a relative primacy of the depicted human faces can be determined at 410 as well. In some implementations, at 412, images that depict human faces (e.g., as a primary feature) are deemed not relevant to the location as a rule. In other implementations, the number and/or relative primacy of human faces can be considered as a factor when determining relevancy at 412 without application of a strict rule. For example, the inclusion of one or more human faces or other portions of humans can negatively affect the relevance score determined for the current image at 412.

At 414, the server computing device 202 determines whether additional images remain. If one or more images remain, then method 400 returns to 408 and considers the next image. In such fashion, the server computing device 202 considers each of the plurality of images. However, if it is determined at 414 that additional images do not remain, then method 400 proceeds to 416.

At 416, the server computing device 202 selects one or more relevant images based at least in part on the relevance scores respectively determined for the plurality of images. As one example, selecting the one or more relevant images at 416 can include selecting a most relevant image of the plurality of images, where the most relevant image is the image that has the greatest relevance score of the plurality of images. As another example, selecting the one or more relevant images at 416 can include selecting any of the plurality of images which have a relevance score greater than a threshold value.

At 418, the server computing device 202 and the mobile computing device 204 cooperatively operate to provide the user of the mobile device with an opportunity to select one or more of the relevant images for association with the location. For example, the mobile computing device 204 can display the notification 102 of FIG. 1 on the display 246 of the mobile computing device 204.

In the instance in which a plurality of relevant images are included in the notification, the notification can provide the user with the ability to swipe between the relevant images and select one or more for submission.

At 420, the server computing device 202 determines whether the user has selected one or more relevant images for association with the location. For example, at 418, the server computing device 202 can determine whether it has received data from mobile computing device 204 which indicates that the user has selected one or more relevant images and assented to the association of such images with the location.

If the user has not assented to association of one or more images with the location, then at 422, the server computing device 202 does not associate any images with the location.

However, if the server computing device 202 determines at 420 that the user has assented to association of one or more images with the location, then method 400 proceeds to 424.

At 424, the server computing device 202 associates the one or more relevant images selected by the user with the location. For example, at 424, the server computing device 202 can store the one or more relevant images selected by the user in the geographic information system 220 and associate such image(s) with the location. Thereafter, the geographic information system 220 can provide the submitted images to additional users who interact with the geographic information system 220 to learn about or review the location.

Although certain portions of method 400 have been discussed as being performed by the server computing device 202, in some implementations, such portions are performed by the mobile computing device 204. Likewise, although certain portions of method 400 have been discussed as being performed by the mobile computing device 204, in some implementations, such portions are performed by the server computing device 202.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to facilitate submission of user-generated images for locations, the method comprising:
determining, by one or more computing devices, a location at which a first image was captured by a mobile computing device;
obtaining, by the one or more computing devices, one or more semantic descriptors that semantically describe the location at which the first image was captured;
analyzing, by the one or more computing devices, the first image to determine one or more subjects of the first image;
determining, by the one or more computing devices, whether the one or more subjects of the first image are related to the one or more semantic descriptors that semantically describe the location; and
when it is determined that the one or more subjects of the first image are related to the one or more semantic descriptors that semantically describe the location, providing, by the one or more computing devices, a user of the mobile computing device with an opportunity to associate the first image with the location.

2. The computer-implemented method of claim 1, wherein determining, by one or more computing devices, the location at which the first image was captured by the mobile computing device comprises determining, by the one or more computing devices, the location at which the first image was captured based at least in part on one or more of a search history associated with the mobile computing device, a location history associated with the mobile computing device, and metadata associated with the first image.

3. The computer-implemented method of claim 1, wherein:
determining, by one or more computing devices, the location at which the first image was captured comprises determining, by the one or more computing devices, geographic coordinates at which the first image was captured; and
obtaining, by the one or more computing devices, the one or more semantic descriptors that semantically describe the location comprises using, by the one or more computing devices, the geographic coordinates to retrieve from a point of interest database associated with a geographic information system the one or more semantic descriptors that describe a point of interest located at the geographic coordinates.

4. The computer-implemented method of claim 1, wherein:
analyzing, by the one or more computing devices, the first image to determine the one or more subjects of the first image comprises performing, by the one or more computing devices, an image content analysis algorithm for the first image to identify the one or more subjects depicted in the first image; and
determining, by the one or more computing devices, whether the one or more subjects of the first image are related to the one or more semantic descriptors comprises comparing, by the one or more computing devices, the one or more subjects with the one or more semantic descriptors.

5. The computer-implemented method of claim 4 wherein comparing, by the one or more computing devices, the one or more subjects with the one or more semantic descriptors comprises determining, by the one or more computing devices, a degree to which the one or more semantic descriptors semantically describe the one or more subjects.

6. The computer-implemented method of claim 1, wherein:
obtaining, by the one or more computing devices, the one or more semantic descriptors comprises obtaining, by the one or more computing devices, a first set of semantic descriptors that semantically describe the location;
analyzing, by the one or more computing devices, the first image to determine the one or more subjects of the first image comprises analyzing, by the one or more computing devices, the first image to determine a second set of semantic descriptors that semantically describe the content of the first image; and
determining, by the one or more computing devices, whether the one or more subjects of the first image are related to the one or more semantic descriptors comprises comparing, by the one or more computing devices, the first set of semantic descriptors with the second set of semantic descriptors to determine a matching magnitude.

7. The computer-implemented method of claim 1, wherein determining, by the one or more computing devices, whether the one or more subjects of the first image are related to the one or more semantic descriptors comprises:
generating, by the one or more computing devices, a relevance score for the one or more subjects of the first image based at least in part on the one or more semantic descriptors; and
determining, by the one or more computing devices, whether the relevance score is greater than a threshold value.

8. The computer-implemented method of claim 1, wherein:
analyzing, by the one or more computing devices, the first image to determine the one or more subjects of the first image comprises analyzing, by the one or more computing devices, the first image to determine whether the first image depicts one or more human faces; and
determining, by the one or more computing devices, whether the one or more subjects of the first image are related to the one or more semantic descriptors comprises determining, by the one or more computing devices, that the one or more subjects of the first image are not related to the one or more semantic descriptors when the first image depicts one or more human faces.

9. The computer-implemented method of claim 1, wherein providing, by the one or more computing devices, the user of the mobile computing device with the opportunity to associate the first image with the location comprises instructing, by the one or more computing devices, the mobile computing device to display a notification on a user interface of the mobile computing device that provides the user of the mobile computing device with the opportunity to upload the first image for association with the location.

10. The computer-implemented method of claim 1, wherein providing, by the one or more computing devices, the user of the mobile computing device with the opportunity to associate the first image with the location comprises providing, by the mobile computing device, a notification on a user interface of the mobile computing device that provides the user of the mobile computing device with the opportunity to upload the first image for association with the location.

11. The computer-implemented method of claim 1, further comprising:
receiving, by the one or more computing devices, data indicative of an assent by the user of the mobile computing device to association of the first image with the location; and
in response to receiving the data indicative of the assent, associating, by the one or more computing devices, the first image with the location in a database associated with a geographic information system.

12. The computer-implemented method of claim 1, further comprising:
detecting, by the one or more computing devices, that the mobile computing device has captured at least the first image;
wherein the method is performed upon detecting that the mobile computing device has captured at least the first image.

13. The computer-implemented method of claim 1, wherein:
determining, by one or more computing devices, the location at which the first image was captured by the mobile computing device comprises determining, by one or more computing devices, the location at which a plurality of images were captured by the mobile computing device, the plurality of images including at least the first image and a second image; and
the method further comprises, when it is determined that the one or more subjects of the first image are not related to the one or more semantic descriptors that semantically describe the location:
disregarding, by the one or more computing devices, the first image;
analyzing, by the one or more computing devices, the second image to identify a second subject of the second image;
determining, by the one or more computing devices, whether the second subject of the second image are related to the one or more semantic descriptors that semantically describe the location; and
when it is determined that the second subject of the second image are related to the one or more semantic descriptors that semantically describe the location, providing, by the one or more computing devices, the user of the mobile computing device with an opportunity to associate the second image with the location.

14. The computer-implemented method of claim 1, wherein the method is performed by the mobile computing device.

15. A computer-implemented method, the method comprising:
determining, by one or more computing devices, a location at which a plurality of images were captured by a mobile computing device;
obtaining, by the one or more computing devices, one or more semantic descriptors that semantically describe the location at which the plurality of images were captured;
analyzing, by the one or more computing devices, the plurality of images to respectively determine a plurality of subjects of the plurality of images;
determining, by the one or more computing devices, a plurality of relevance scores respectively for the plurality of subjects of the plurality of images, the relevance score for the subject of each image based at least in part on a comparison of such subject to the one or more semantic descriptors;
selecting, by the one or more computing devices, one or more relevant images of the plurality of images based at least in part on the plurality of relevance scores; and
providing, by the one or more computing devices, a user of the mobile computing device with an opportunity to associate the one or more relevant images with the location.

16. The computer-implemented method of claim 15, wherein:
selecting, by the one or more computing devices, one or more relevant images of the plurality of images based at least in part on the plurality of relevance scores comprises selecting, by the one or more computing devices, a most relevant image of the plurality of images, the most relevant image having the greatest relevance score of the plurality of images; and
providing, by the one or more computing devices, the user of the mobile computing device with the opportunity to associate the one or more relevant images with the location comprises providing, by the one or more computing devices, the user of the mobile computing device with the opportunity to associate the most relevant image with the location.

17. The computer-implemented method of claim 15, wherein:
selecting, by the one or more computing devices, one or more relevant images of the plurality of images based at least in part on the plurality of relevance scores comprises selecting, by the one or more computing devices as the relevant images, any of the plurality of images which have a relevance score greater than a threshold value; and
providing, by the one or more computing devices, the user of the mobile computing device with the opportunity to associate the one or more relevant images with the location comprises providing, by the one or more computing devices, the user of the mobile computing device with the opportunity to select one or more of the relevant images for association with the location.

18. A computing system, comprising:
a mobile computing device that includes a camera;
a point of interest database that stores semantic descriptors and images associated with a plurality of locations, wherein the semantic descriptors associated with each location respectively semantically describe such location, the point of interest database a component of a geographic information system; and
one or more server computing devices communicatively coupled to the mobile computing device and to the point of interest database over a network;
wherein at least one of the mobile computing device and the one or more server computing devices comprises a non-transitory computer-readable medium storing instructions which, when executed by one or more processors, cause the at least one of the mobile computing device and the one or more server computing devices to:
determine a location at which a first image was captured by the camera of the mobile computing device;
obtain from the point of interest database a first set of semantic descriptors that semantically describe the location at which the first image was captured;
analyze the first image to determine one or more subjects of the first image;
determine whether the one or more subjects of the first image are related to the one or more semantic descriptors that semantically describe the location; and
when it is determined that the one or more subjects of the first image are related to the one or more semantic descriptors that semantically describe the location, cause a notification to be provided to a user of the mobile computing device, wherein the notification provides the user of the mobile computing device with an opportunity to have the first image stored in the point of interest database and associated with the location.

19. The computing system of claim 18, wherein:
the instructions which cause the at least one of the mobile computing device and the one or more server computing devices to analyze the first image to determine the one or more subjects of the first image cause the at least one of the mobile computing device and the one or more server computing devices to analyze the first image to determine a second set of semantic descriptors that semantically describe the content of the first image; and
the instructions which cause the at least one of the mobile computing device and the one or more server computing devices to determine whether the one or more subjects of the first image are related to the one or more semantic descriptors that semantically describe the location cause the at least one of the mobile computing device and the one or more server computing devices to compare the first set of semantic descriptors and the second set of semantic descriptors to determine a relevance score for the first image, the first image determined to be related to the one or more semantic descriptors when the relevance score exceeds a threshold value.

20. The computing system of claim 18, wherein the instructions which cause the at least one of the mobile computing device and the one or more server computing devices to analyze the first image to determine the one or more subjects of the first image cause the at least one of the mobile computing device and the one or more server computing devices to perform one or more object recognition routines and one or more object classification routines for the first image to recognize and classify one or more objects depicted in the first image.
